(19) United States
(12) Patent Application Publication
(10) Pub. No.: US 2015/0377366 A1
(43) Pub. Date: Dec. 31, 2015

(54) Ball Valve and Method of Operating the Same

(71) Applicants: Thomas A. Hartman, St. Louis, MO (US); Brian T. Hartman, Mesa, AZ (US)

(72) Inventors: Thomas A. Hartman, St. Louis, MO (US); Brian T. Hartman, Mesa, AZ (US)

(21) Appl. No.: 14/319,788

(22) Filed: Jun. 30, 2014

(51) Int. Cl. F16K 5/20; F16K 5/06

(52) U.S. Cl. CPC F16K 5/204; F16K 5/0689

(57) ABSTRACT

A ball valve comprises a selectively movable valve seat on its ball plug that is pressure actuated. The ball valve also comprises a moveable upstream valve seat that can selectively be seated by pressure actuation. The upstream valve seat thereafter will remain seated until the pressures upstream and downstream of the upstream valve are equalized.

### CROSS-REFERENCE TO RELATED APPLICATIONS

Not Applicable.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

This invention relates generally to large industrial valves for controlling the flow of fluids therethrough. More particularly, this invention pertains to ball valves having valve seats that are selectively movable when the ball plugs of such valves are in the closed position.

2. General Background

Ball valves are used in various industries for controlling the flow of fluids. An advantage of using a ball valve over other types of valves is that, when open, fluid is able to pass through the valve unobstructed. Thus, very little pressure loss occurs as fluid passes through the ball plug. The ball plug is typically pivotally attached to the housing via a pair of trunnions in a manner such that it can pivot between opened and closed positions. In the closed position, a valve seat on the ball plug can be engaged with a valve seat on the housing to prevent the flow of fluid through the valve. Typically, the valve seats engage each other automatically when the ball plug is in the closed position. However, in some cases the engagement pressure between the valve seats is high enough to warrant some means of relieving at least some of the pressure between the valve seats prior to pivotally moving the ball plug away from or into the closed position. That has been accomplished by making the valve seat on the housing movable toward and away from the ball plug. For example, some valves are configured such that fluid pressure can be applied to an actuation chamber in a manner that moves and urges the valve seat of the housing against the valve seat of the ball plug. To disengage the valve seat of such valves from each other, the fluid pressure within the actuation chamber is decreased to at least a degree such that fluid pressure within the valve forces the valve seat of the housing away from the ball valve. Thus, to sealably close such a valve, the fluid pressure within the actuation chamber must be large enough to overcome the fluid pressure within the valve upstream of said valve seats. If a failure causes an appreciable drop in pressure within the actuation chamber, the valve can fail in a non-sealed mode.

### SUMMARY OF THE INVENTION

The present invention is directed to ball valves. More specifically, the present invention is directed to ball valves that have at least one valve seat that is movable relative to another valve seat of the ball valve when the ball valve is in a closed position.

In one aspect of the invention, a ball valve comprises a housing and a ball plug. The housing comprises a primary fluid passageway and an annular valve seat. The primary fluid passageway extends through the housing. The ball plug is positioned within the primary fluid passageway of the housing and comprises a main body portion, a pair of trunnions, a primary fluid passageway, and a valve seat. The trunnions pivotally connect the ball plug to the housing in a manner such that the ball plug can pivot to and between an open position and a closed position relative to the housing. The primary fluid passageway of the ball plug extends through the main body of the ball plug. The ball valve is configured and adapted to allow fluid to flow through the annular valve seat of the housing and through the primary fluid passageway of the ball plug and the primary fluid passageway of the housing when the ball plug is in the open position. The valve seat of the ball plug is configured and adapted to engage the annular valve seat of the housing in a manner preventing fluid from passing through the annular valve seat of the housing when the ball plug is in the closed position. The valve seat of the ball plug is also selectively movable relative to the main body portion of the ball plug such that the valve seat of the ball plug can be selectively urged toward the trunnions.

Another aspect of the invention pertains to a method of operating a ball valve. The ball valve comprises a housing and a ball plug. The housing comprises a primary fluid passageway and an annular valve seat. The primary fluid passageway extends through the housing. The ball plug is positioned within the primary fluid passageway of the housing and comprises a main body portion, a pair of trunnions, a primary fluid passageway, and a moveable valve seat. The trunnions pivotally connect the ball plug to the housing in a manner such that the ball plug can pivot to and between an open position and a closed position relative to the housing. The primary fluid passageway of the ball plug extends through the main body of the ball plug. The method comprises disengaging the valve seat of the ball plug from the annular valve seat of the housing by moving the valve seat of the ball plug toward the trunnions.

In still another aspect of the invention, a ball valve comprises a housing and a ball plug. The housing comprises a primary fluid passageway, a movable annular valve seat, and at least one compression spring. The primary fluid passageway extends through the housing and through the annular valve seat of the housing. The ball plug is positioned within the primary fluid passageway of the housing and comprises a main body portion, a pair of trunnions, a primary fluid passageway, and a valve seat. The trunnions pivotally connect the ball plug to the housing in a manner such that the ball plug can pivot to and between an open position and a closed position relative to the housing. The primary fluid passageway of the ball plug extends through the main body of the ball plug. The ball valve is configured and adapted to allow fluid to flow through the annular valve seat of the housing and through the primary fluid passageway of the ball plug and the primary fluid passageway of the housing when the ball plug is in the open position, and such that the annular valve seat of the housing can be engaged with the valve seat of the ball plug when the ball plug is in the closed position. The ball valve is further configured and adapted such that the annular valve seat of the housing can be disengaged with the valve seat of the ball plug when the ball plug is in the closed position. The compression spring urges the annular valve seat of the housing away from the valve seat of the ball plug when the ball plug is in the closed position in a manner such that, absent other forces acting on the annular valve seat, the annular valve will be spaced from the valve seat of the ball plug.

In yet another aspect of the invention, a method of operating a ball valve comprises closing a ball valve. The ball valve comprises a housing and a ball plug. The housing comprises a primary fluid passageway, a movable annular valve seat, an actuation chamber, and at least one compression spring. The primary fluid passageway extends through the housing and through the annular valve seat of the housing. The actuation chamber is partially bound by the annular valve seat of the housing. The ball plug is positioned within the primary fluid passageway of the housing and comprises a main body portion, a pair of trunnions, a primary fluid passageway, and a valve seat. The trunnions pivotally connect the ball plug to the housing in a manner such that the ball plug can pivot to and between an open position and a closed position relative to the housing. The primary fluid passageway of the ball plug extends through the main body of the ball plug. The compression spring urges the annular valve seat of the housing away from the valve seat of the ball plug when the ball plug is in the closed position. The method further comprises pressurizing the actuation chamber of the housing when the ball plug is in the closed position in a manner overcoming the urging caused by the compression spring and such that the annular valve seat of the housing engages and seals against the valve seat of the ball plug. Still further, the method comprises disengaging the annular valve seat of the housing with the valve seat of the ball plug by depressurizing the actuation chamber of the housing and pressurizing the primary fluid passageway of the ball plug.

Further features and advantages of the present invention, as well as the operation of the invention, are described in detail below with reference to the accompanying drawings.

### BRIEF DESCRIPTION OF THE DRAWINGS

FIG. 1 depicts a perspective view of a ball valve in accordance with the invention, showing the front, top, and left sides thereof and its ball plug in the closed position.

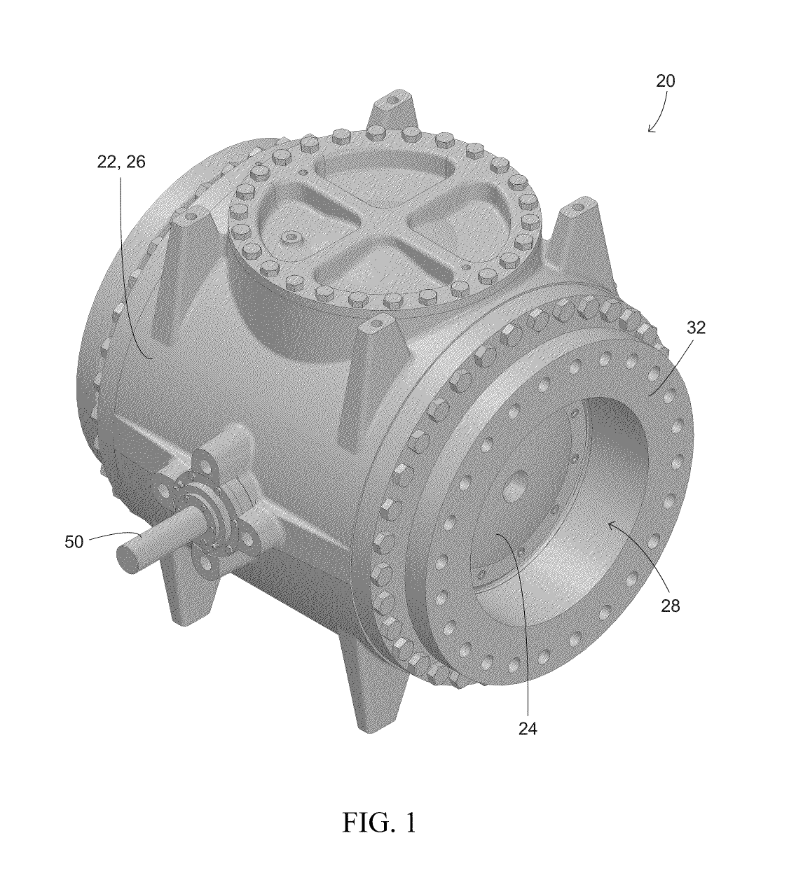

FIG. 2 depicts another perspective view of a ball valve in accordance with the invention, showing the front, top, and right sides thereof and its ball plug in the opened position.

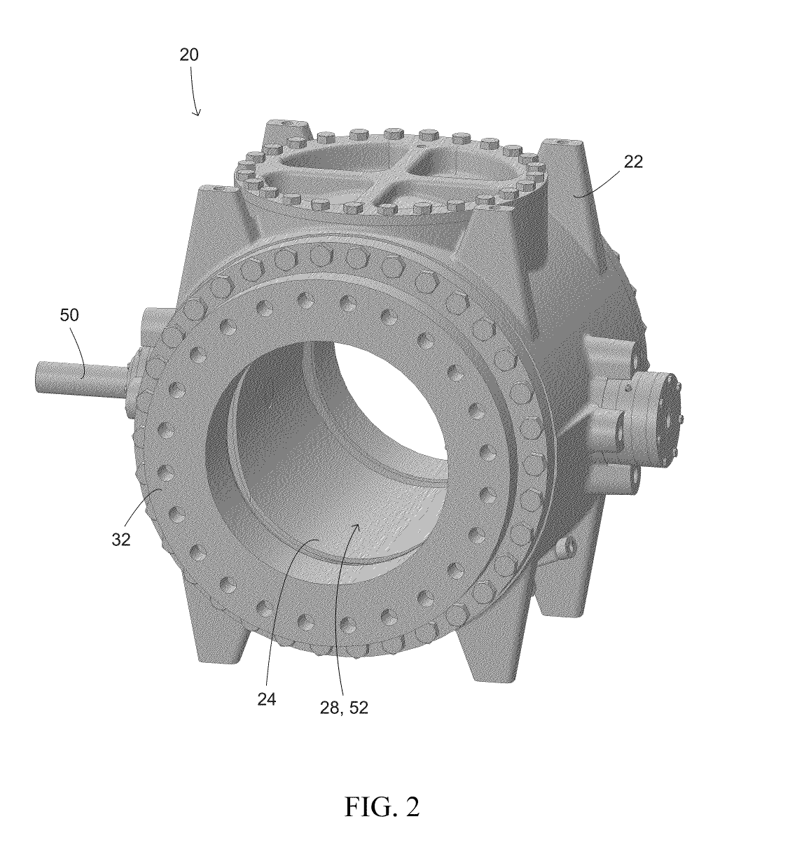

FIG. 3 depicts a cross-section of the ball valve shown in FIGS. 1 and 2, taken about a horizontal plane passing through the axis of the trunnions, and shows the ball plug in the closed position.

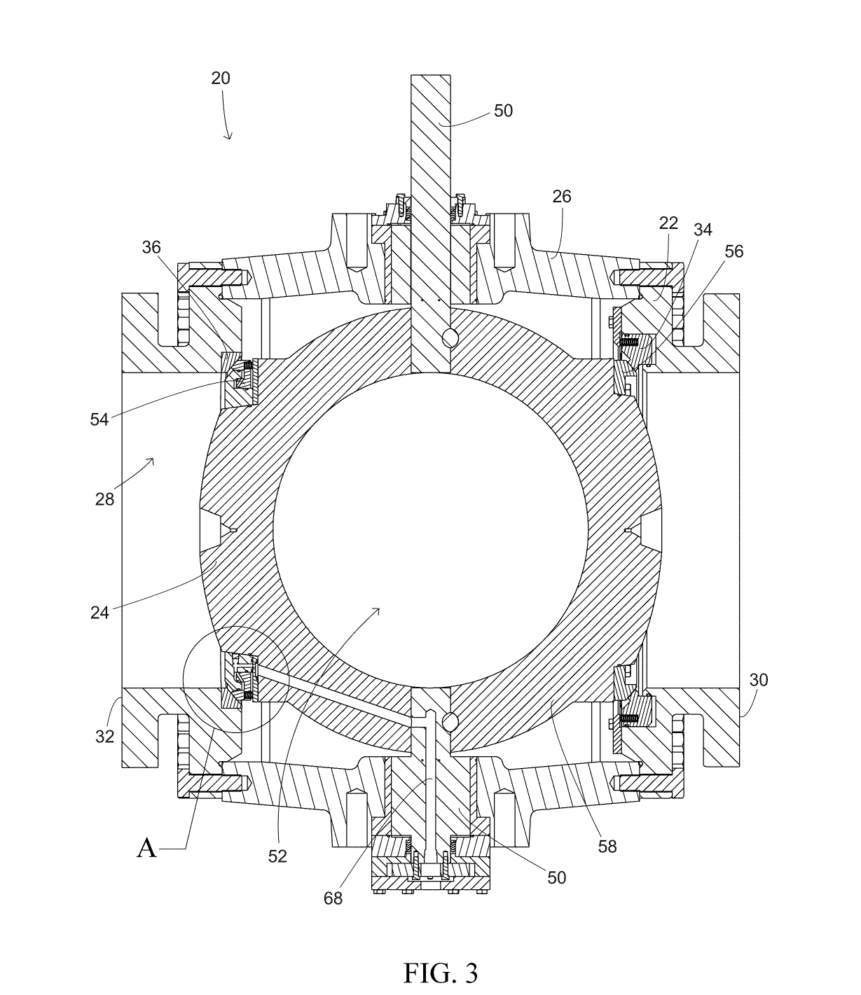

FIG. 4 depicts a cross-section of the ball valve shown in FIGS. 1 through 3, taken about a vertical plane that is perpendicular to the axis of the trunnions and passes centrally through the valve, and shows the ball plug in the closed position.

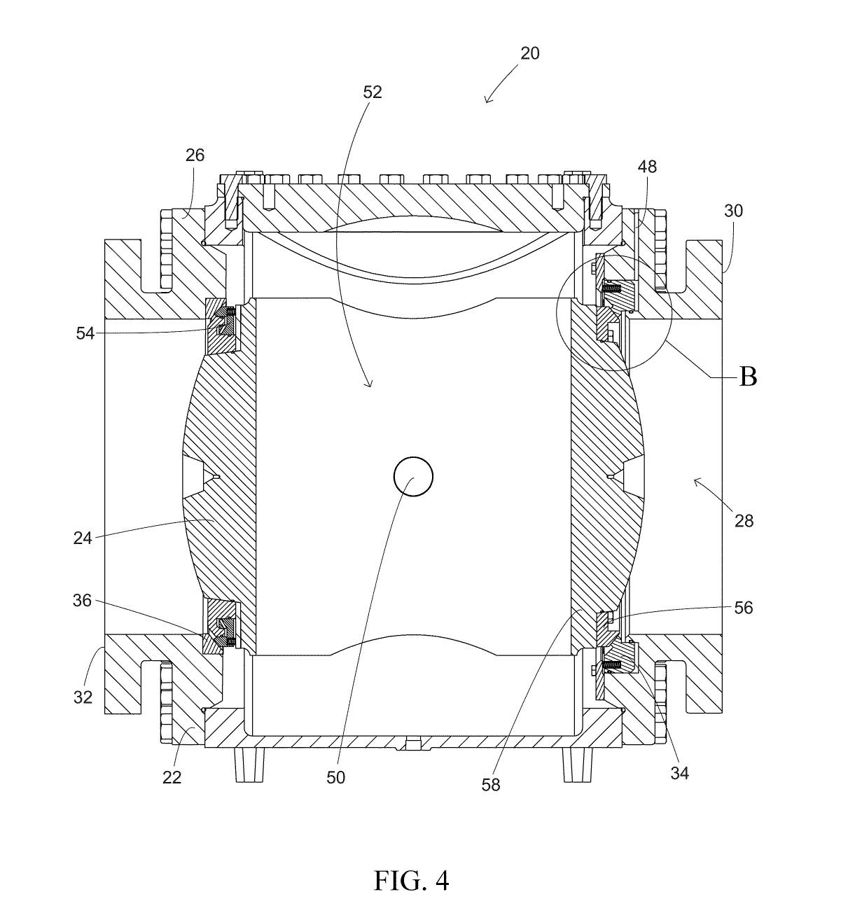

FIG. 5 is a view of detail A shown in FIG. 3 and shows the downstream valve seat of the ball plug engaged against the downstream valve seat of the housing.

FIG. 6 is a view of detail A shown in FIG. 3 except that it shows the downstream valve seat of the ball plug disengaged from the downstream valve seat of the housing.

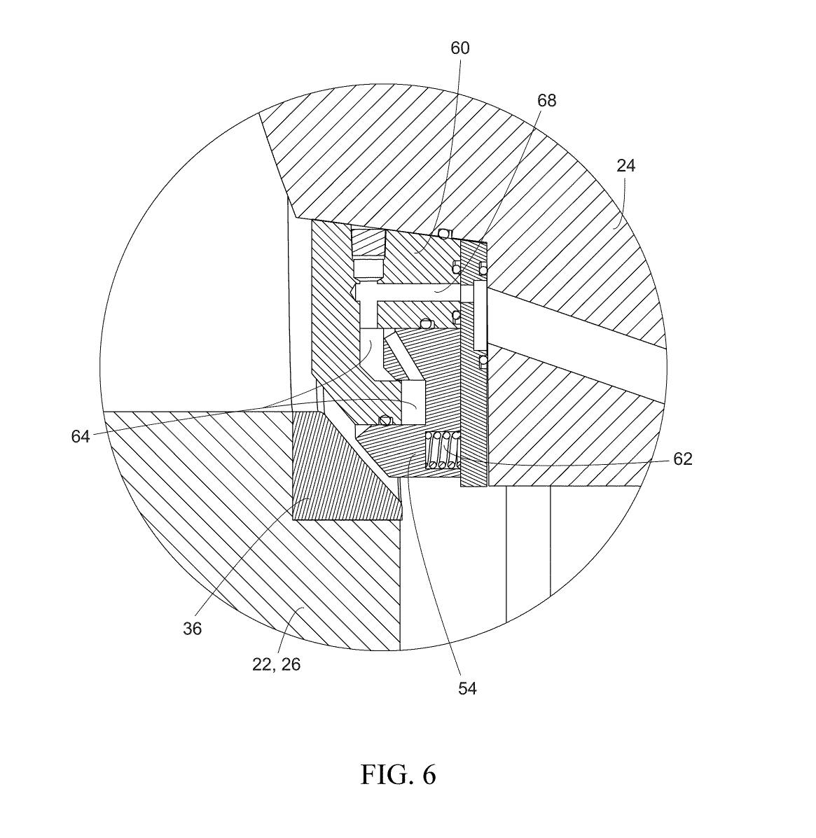

FIG. 7 is a view of detail B shown in FIG. 4 and shows the upstream valve seat of the housing engaged against the upstream valve seat of the ball plug.

FIG. 8 is a view of detail B shown in FIG. 4 except that it shows the upstream valve seat of the housing disengaged from the upstream valve seat of the ball plug.

Reference numerals in the written specification and in the drawing figures indicate corresponding items.

### DETAILED DESCRIPTION

A ball valve in accordance with the invention is shown in the figures, as indicated by reference numeral 20. The ball valve 20 comprises a housing 22 and a ball plug 24. The ball plug 24 is pivotally mounted within and relative to the housing 22 about an axis such that the ball plug can pivot between a fully opened position and a fully closed position. When the ball plug 24 is in the opened position, fluid is permitted to flow unobstructed through the ball valve 20 and ball plug. When the ball plug 24 is in the closed position, the ball plug can prevent fluid from flowing through the ball valve 20.

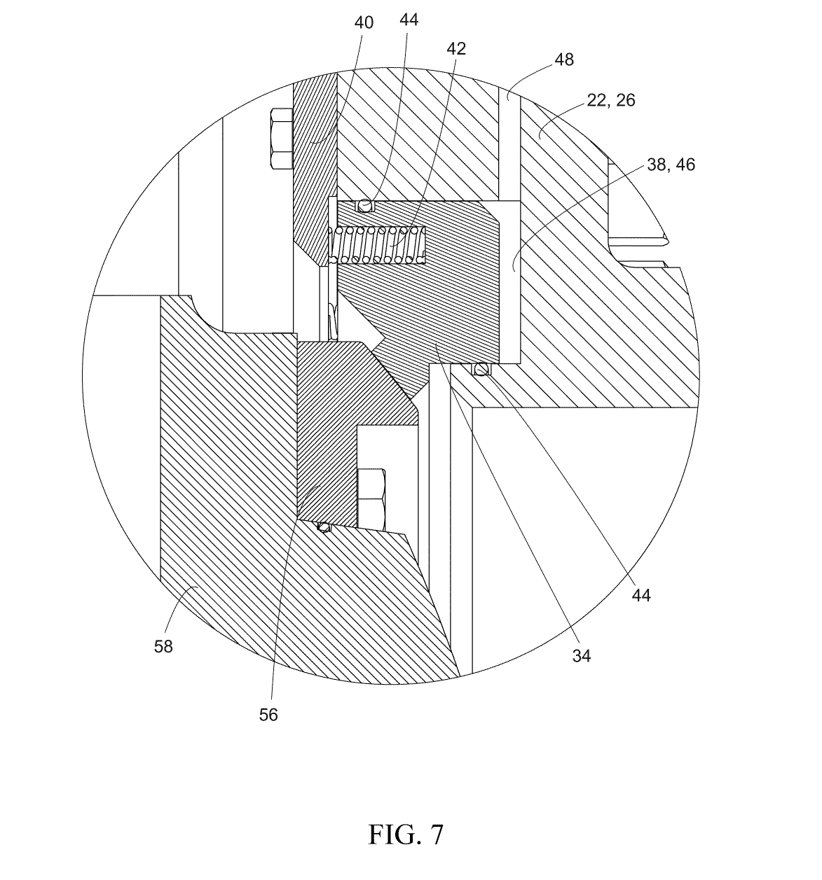

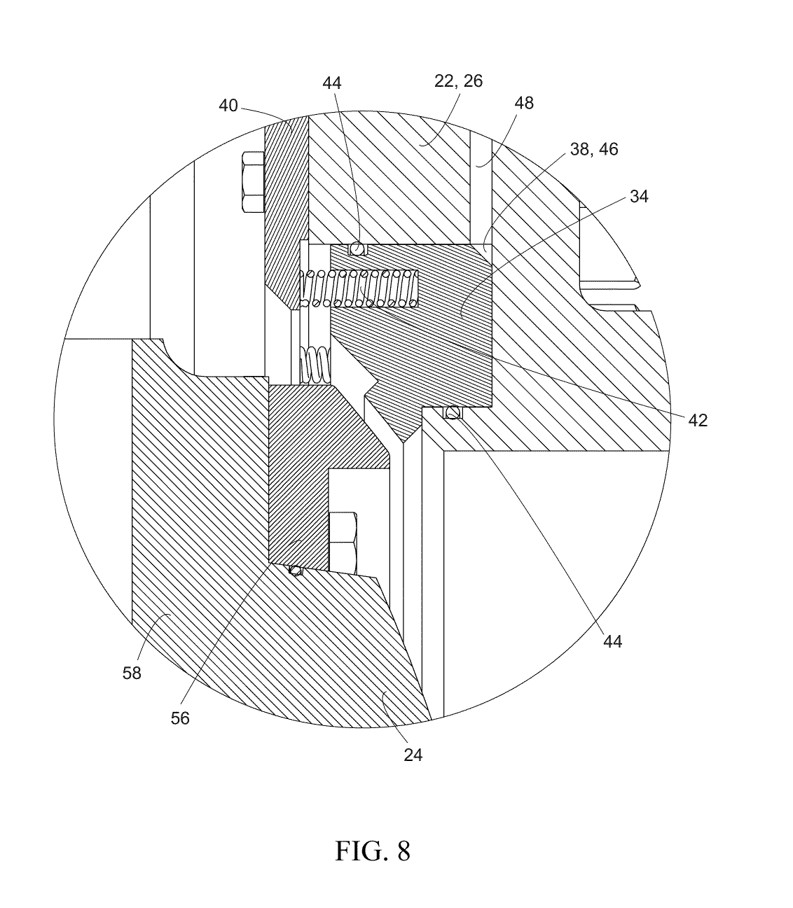

The housing 22 comprises a generally cylindrical and tubular valve body 26. The valve body 26 comprises a fluid passageway 28 that extends through the valve body from an upstream end 30 to a downstream end 32 of the valve body. The housing 22 also comprises a movable upstream annular valve seat 34 and a stationary downstream annular valve seat 36 that are secured to the valve body 26. As shown in FIGS. 7 and 8, the valve body 26 also comprises an annular recess 38. The upstream annular valve seat 34 is slideably received in the annular recess 38 in a manner such that the upstream annular valve seat is movable toward and away from the ball plug 24. A removable retaining ring 40 downstream of and adjacent to the upstream annular valve seat 34 secures the upstream annular valve seat to the valve body 26. A plurality of compression springs 42 are circumferentially spaced from each other and are compressed between the retaining ring 40 and the upstream annular valve seat 34. A pair of annular O-rings 44 are sandwiched between the upstream annular valve seat 34 and the circumferential walls of the annular recess 38. The annular recess 38 and the upstream annular valve seat 34 collectively define an annular actuation chamber 46 upstream of the upstream annular valve seat 34. The actuation chamber 46 is fluidly sealed from the fluid passageway 28 of the valve body 26 by the O-rings 44. A pressure supply passageway 48 extends through the valve body 26 and is operatively connected to the actuation chamber 46 of the valve body.

The ball plug 24 is pivotally secured within the fluid passageway of the valve body 26 and to the valve body via trunnions 50. Like the valve body 26, the ball plug 24 comprises a fluid passway 52 that extends through the ball plug perpendicular to the axis of the trunnions 50. The ball plug 24 also comprises a movable downstream annular valve seat 54 and a stationary upstream annular valve seat 56. The upstream annular valve seat 56 of the ball plug is bolted to the main body 58 of the ball plug. The downstream annular valve seat is secured to the main body 58 of the ball plug 24 by a removable retaining ring 60. A plurality of compression springs 62 are circumferentially spaced from each other and urge the movable downstream valve seat 54 of the ball plug 24 away from the trunnions 50 (i.e., downstream when the ball plug is in its closed position). An actuation chamber 64 is formed collectively by the retaining ring 60 and the downstream valve seat 54 and is fluidly sealed from the fluid passageway 28 of the valve body 26 by O-rings 66. A pressure supply passageway 68 extends through one of the trunnions 50, the main body 58 of the ball plug 24, and the retaining ring of the ball plug 24, and is operatively connected to the actuation chamber 64 of the ball plug.

In operation, the upstream annular valve seats 34, 56 or the downstream annular valve seats 36, 54 can be used to prevent fluid from passing through the valve 20 when the ball plug 24 is in its closed position. The downstream annular valve seats 36, 54 are preferably the primary valve seats and the upstream annular valve seats 34, 56 preferably serve as “safety” valve seats. However, in some applications, it could be beneficial to use the upstream annular valve seats 34, 56 as primary valve seats. Moreover, it should be appreciated that the upstream annular valve seats 34, 56 operate independently of the downstream annular valve seats 36, 54 and a valve in accordance with the invention need not comprise both upstream and downstream sets of valve seats.

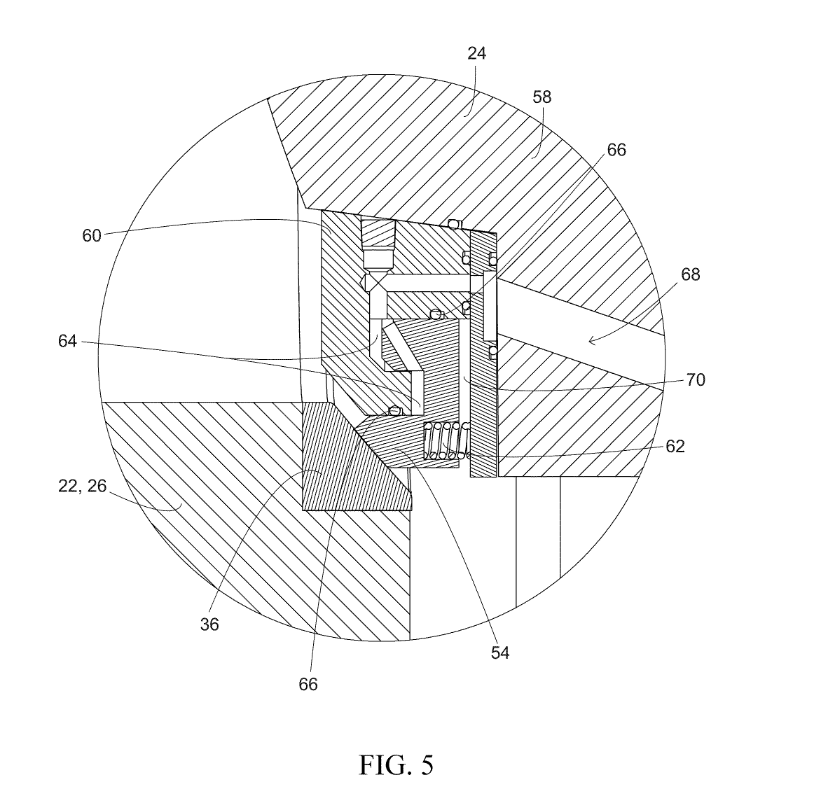

Since the downstream annular valve seats 36, 54 are preferably the primary valve seats, the use of the downstream annular valve seats 36, 54 will be described first. With the ball plug 24 in its closed position, the downstream annular valve seats 36, 54 can be engaged with each other to thereby prevent fluid from passing through the downstream annular valve seat 36 of the housing 22, as is shown in FIG. 5. As can be seen in FIG. 5, when the downstream annular valve seats 36, 54 are engaged with each other, an annular gap 70 in communication with the fluid passageway 28 of the valve body 26 is formed immediately upstream of the downstream annular valve seat 54 of the ball plug 24. As such, fluid pressure within the fluid passageway 28 of the valve body 26 urges the downstream annular valve seat 54 of the ball plug 24 away from the trunnions 50 and toward the fixed downstream annular valve seat 36 of the housing 22. Assuming that the pressure within the actuation chamber 64 of the ball plug 24 is equal to or less than the fluid pressure within the fluid passageway 28 of the valve body 26 and assuming that fluid within the actuation chamber is either compressible or can exit the actuation chamber via the pressure supply passageway 68 of the ball plug 24, the annular valve seat 54 of the ball plug 24 will therefore engage the fixed downstream annular valve seat 36 of the housing 22, which prevents fluid from passing through the downstream annular valve seat of the housing. Prior to pivoting the ball plug to its open position, the actuation chamber 64 of the ball plug 24 can be pressurized via the pressure supply passageway 68 of the ball plug 24. Pressure in the actuation chamber 64 of the ball plug 24 urges the downstream annular valve seat 54 of the ball plug 24 toward the trunnions 50. Thus, by pressurizing the actuation chamber 64 of the ball plug 24, contact force between the downstream annular valve seats 36, 54 is reduced. If the pressure in the actuation chamber is greater than the fluid pressure in the fluid passageway 28 of the valve body 26, the downstream annular valve seat 54 of the ball plug 24 can be separated from the downstream annular valve seat 36 of the housing 22 when the ball plug is in its closed position. The pressure supplied to the actuation chamber 64 of the ball plug 24 can be supplied from any source including, but not limited to, a hydraulic or pneumatic pump or stepped-up pressure generated from upstream penstock pressure. Preferably, the downstream annular valve seat 54 of the ball plug 24 is separated from the downstream annular valve seat 36 of the housing 22 prior to pivoting the ball plug from its closed position. Similarly, preferably the actuation chamber 64 of the ball plug 24 is pressurized to retract the downstream annular valve seat 54 of the ball plug 24 toward the trunnions 50 when the ball plug is pivoted to its closed position. This prevents the downstream valve seats 36, 54 from galling. When closing the valve 20, the pressure in the actuation chamber 64 of the ball plug 24 is released or decreased after the ball plug 24 reaches its closed position. The urging of the compression springs 62 of the ball plug 24 then cause the downstream annular valve seat 54 to move away from the trunnions 50, thereby opening the annular gap 70 immediately upstream of the downstream annular valve seat 54. Thus, fluid pressure within the fluid passageway 28 of the valve body 26 thereafter urges the downstream annular valve seat 54 of the ball plug 24 against the fixed downstream annular valve seat 36 of the housing 22 and thereby seals the valve 20 closed.

In view of the foregoing it should be appreciated that any leak or loss of pressure in the actuation chamber 64 or pressure supply passageway 68 of the ball plug 24 will not cause the downstream annular valve seats 36, 54 of the valve 20 to unseat when the valve is closed. Moreover, it should be appreciated that the actuation chamber 64 and pressure supply passageway 68 of the ball plug 24 need only be pressurized when opening or closing the valve 20.

Turning now to the upstream annular valve seats 34, 56, reference is made to FIGS. 7 and 8. FIG. 7 depicts the upstream annular valve seats 34, 56 seated and FIG. 8 depicts them unseated. When the pressure supply passageway 48, and therefore the actuation chamber 46, is unpressurized and the upstream annular valve seats 34, 56 are unseated, the compression springs 42 between the upstream annular valve seat 34 and the retaining ring 40 of the housing 22 prevent the annular valve seats 34, 56 from seating. However, when the pressure supply passageway 48 and the actuation chamber 46 are sufficiently pressurized, the pressure will move the upstream annular valve seat 34 of the housing 22 into engagement with the upstream annular valve seat 56 of the ball plug. Preferably, penstock pressure is used to pressurize supply passageway 48 and the actuation chamber 46. Once seated, so long as there is a pressure differential across the closed upstream annular valve seats 34, 56, the pressure differential will prevent the upstream annular valve seats from unseating, even if the pressure supply passageway 48 and the actuation chamber 46 lose pressure. Thus, to unseat the upstream annular valve seats 34, 56, it is preferably necessary to first pressurize the fluid passageway 28 of the housing 22 downstream of the upstream annular valve seats. As such, the upstream annular valve seats 34, 56 serve well as a safety shut-off. For example, when components downstream of the ball valve 20 are in need of servicing, the upstream annular valve seats 34, 56 of the ball valve can be seated prior to or without also seating the downstream annular valve seats 36, 54. Thereafter, flow through the valve 20 cannot resume until the upstream and downstream pressures are equalized. That can be achieved via a low-flow bypass line at any location downstream of the upstream annular valve seats 34, 56. Once the upstream and downstream pressures are equalized (or near equal), the compression springs 42 between the upstream annular valve seat 34 and the retaining ring 40 of the housing 22 will move the annular valve seat 34 away from the upstream annular valve seat 56 of the ball plug 24.

Although a ball valve 20 may incorporate either only the upstream annular valve seats 34, 56 or the downstream annular valve seats 36, 54, providing a ball valve with both has additional advantages. For example, if the downstream annular valve seats 36, 54 serve as the primary valve seats and the stationary downstream annular valve seat 36 of the housing 22 is in need of servicing, the upstream annular valve seats 34, 56 can be used to close the valve while the downstream annular valve seat 36 is being serviced. Following such servicing, the downstream annular valve seats 36, 54 could be seated and a bypass line could thereafter be used to pressurize the fluid passageway between the upstream annular valve seats and the downstream annular valve seats until the upstream annular valve seat unseat. Thereafter, normal operation of the downstream annular valve seats 36, 54 could resume.

In view of the foregoing, it should be appreciated that the invention has several advantages over the prior art.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed, unless such an order is inherent.

What is claimed is:

1. A ball valve comprising a housing and a ball plug, the housing comprising a primary fluid passageway and an annular valve seat, the primary fluid passageway extending through the housing, the ball plug being positioned within the primary fluid passageway of the housing and comprising a main body portion, a pair of trunnions, a primary fluid passageway, and a valve seat, the trunnions pivotally connecting the ball plug to the housing in a manner such that the ball plug can pivot to and between an open position and a closed position relative to the housing, the primary fluid passageway of the ball plug extending through the main body of the ball plug, the ball valve being configured and adapted to allow fluid to flow through the annular valve seat of the housing and through the primary fluid passageway of the ball plug and the primary fluid passageway of the housing when the ball plug is in the open position, the valve seat of the ball plug being configured and adapted to engage the annular valve seat of the housing in a manner preventing fluid from passing through the annular valve seat of the housing when the ball plug is in the closed position, the valve seat of the ball plug also being selectively movable relative to the main body portion of the ball plug such that the valve seat of the ball plug can be selectively urged toward the trunnions.

2. A ball valve in accordance with claim 1 wherein the valve seat of the ball plug is selectively movable relative to the main body portion of the ball plug such that the valve seat of the ball plug can be disengaged with the annular valve seat of the housing when the ball plug is in the closed position.

3. A ball valve in accordance with claim 1 wherein the ball plug is configured and adapted such that, when the valve seat of the ball plug is engaged with the annular valve seat of the housing, fluid pressure within the primary fluid passageway of the housing will urge the valve seat of the ball plug toward the annular valve seat of the housing and away from the trunnions.

4. A ball valve in accordance with claim 1 wherein the ball plug comprises an actuation chamber that is partially bound by the valve seat of the ball plug, and the ball plug is configured such that fluid pressure within the actuation chamber urges the valve seat of the ball plug toward the trunnions.

5. A ball valve in accordance with claim 4 wherein the ball plug comprises a fluid passageway that extends within at least one of the trunnions and to the actuation chamber.

6. A ball valve in accordance with claim 4 wherein the ball plug comprises a compression spring that urges the valve seat of the ball plug away from the trunnions.

7. A method of operating a ball valve, the ball valve comprising a housing and a ball plug, the housing comprising a primary fluid passageway and an annular valve seat, the primary fluid passageway extending through the housing, the ball plug being positioned within the primary fluid passageway of the housing and comprising a main body portion, a pair of trunnions, a primary fluid passageway, and a moveable valve seat, the trunnions pivotally connecting the ball plug to the housing in a manner such that the ball plug can pivot to and between an open position and a closed position relative to the housing, the primary fluid passageway of the ball plug extending through the main body of the ball plug, the method comprising:
disengaging the valve seat of the ball plug from the annular valve seat of the housing by moving the valve seat of the ball plug toward the trunnions.

8. A method in accordance with claim 7 wherein the ball plug comprises an actuation chamber that is partially bound by the valve seat of the ball plug and the moving of the valve seat of the ball plug toward the trunnions involves pressurizing a fluid within the actuation chamber of the ball plug.

9. A method in accordance with claim 8 wherein the ball plug comprises a secondary fluid passageway that extends within at least one of the trunnions and to the actuation chamber, and the pressurizing of the fluid within the actuation chamber of the ball plug involves pressuring fluid within the secondary fluid passageway in the at least one of the trunnions.

10. A method in accordance with claim 7 wherein the ball plug comprises a compression spring that urges the valve seat of the ball plug away from the trunnions and the moving of the valve seat of the ball plug toward the trunnions require overcoming said urging.

11. A ball valve comprising a housing and a ball plug, the housing comprising a primary fluid passageway, a movable annular valve seat, and at least one compression spring, the primary fluid passageway extending through the housing and through the annular valve seat of the housing, the ball plug being positioned within the primary fluid passageway of the housing and comprising a main body portion, a pair of trunnions, a primary fluid passageway, and a valve seat, the trunnions pivotally connecting ball plug to the housing in a manner such that the ball plug can pivot to and between an open position and a closed position relative to the housing, the primary fluid passageway of the ball plug extending through the main body of the ball plug, the ball valve being configured and adapted to allow fluid to flow through the annular valve seat of the housing and through the primary fluid passageway of the ball plug and the primary fluid passageway of the housing when the ball plug is in the open position, the ball valve being configured and adapted such that the annular valve seat of the housing can be engaged with the valve seat of the ball plug when the ball plug is in the closed position, the ball valve also being configured and adapted such that the annular valve seat of the housing can be disengaged with the valve seat of the ball plug when the ball plug is in the closed position, the compression spring urging the annular valve seat of the housing away from the valve seat of the ball plug when the ball plug is in the closed position in a manner such that, absent other forces acting on the annular valve seat, the annular valve will be spaced from the valve seat of the ball plug.

12. A ball valve in accordance with claim 11 wherein the housing comprises an actuation chamber that is partially bound by the annular valve seat of the housing, and the housing is configured such that fluid pressure within the actuation chamber will urge the annular valve seat of the housing toward the valve seat of the ball plug when the ball plug is in the closed position.

13. A ball valve in accordance with claim 11 wherein the valve seat of the ball plug is a first valve seat and the ball plug comprises a second valve seat, the annular valve seat of the housing is a first annular valve seat and the housing comprises a second annular valve seat, the second valve seat of the ball plug is configured and adapted to engage the second annular valve seat of the housing in a manner preventing fluid from passing through the second annular valve seat of the housing when the ball plug is in the closed position, and the second valve seat of the ball plug is selectively movable relative to the main body portion of the ball plug such that the second valve seat of the ball plug can be selectively urged toward the trunnions.

14. A method of operating a ball valve comprising:
closing a ball valve, the ball valve comprising a housing and a ball plug, the housing comprising a primary fluid passageway, a movable annular valve seat, an actuation chamber, and at least one compression spring, the primary fluid passageway extending through the housing and through the annular valve seat of the housing, the actuation chamber being partially bound by the annular valve seat of the housing, the ball plug being positioned within the primary fluid passageway of the housing and comprising a main body portion, a pair of trunnions, a primary fluid passageway, and a valve seat, the trunnions pivotally connecting ball plug to the housing in a manner such that the ball plug can pivot to and between an open position and a closed position relative to the housing, the primary fluid passageway of the ball plug extending through the main body of the ball plug, the compression spring urging the annular valve seat of the housing away from the valve seat of the ball plug when the ball plug is in the closed position;
pressurizing the actuation chamber of the housing when the ball plug is in the closed position in a manner overcoming the urging caused by the compression spring and such that the annular valve seat of the housing engages and seals against the valve seat of the ball plug;
disengaging the annular valve seat of the housing with the valve seat of the ball plug by depressurizing the actuation chamber of the housing and pressurizing the primary fluid passageway of the ball plug.
